(19) United States
(12) Patent Application Publication
(10) Pub. No.: US 2012/0001903 A1
(43) Pub. Date: Jan. 5, 2012

(54) DISPLAY APPARATUS

(75) Inventors: Takaaki ABE, Takatsuki-City (JP); Ken MASHITANI, Hirakata-City (JP); Masutaka INOUE, Hirakata-City (JP)

(73) Assignee: SANYO ELECTRIC CO., LTD., Moriguchi City (JP)

(21) Appl. No.: 13/171,983

(22) Filed: Jun. 29, 2011

(30) Foreign Application Priority Data
Jun. 30, 2010 (JP) 2010-150492
Mar. 29, 2011 (JP) 2011-072842

(51) Int. Cl. G06T 15/00

(52) U.S. Cl. 345/419

(57) ABSTRACT

An display apparatus displays a three-dimensional image formed of a plurality of viewpoint images, and includes an image controller that controls a second viewpoint image to suppress a crosstalk of a first viewpoint image the first viewpoint image and the second viewpoint image are included in the plurality of viewpoint images. The image controller switches a control mode for suppressing the crosstalk, between a subtraction mode and an addition mode in accordance with an image input signal forming the three-dimensional image.

### CROSS REFERENCE TO RELATED APPLICATIONS

This application is based upon and claims the benefit of priority from prior Japanese Patent Application No. 2010-150492, filed on Jun. 30, 2010; and prior Japanese Patent Application No. 2011-072842, filed on Mar. 29, 2011; the entire contents of which are incorporated herein by reference.

### BACKGROUND OF THE INVENTION

1. Field of the Invention

The present invention relates to a display apparatus for displaying one frame of a three-dimensional image formed of multiple viewpoint images.

2. Description of the Related Art

A three-dimensional image formed of multiple viewpoint images (for example, a left-eye viewpoint image and a right-eye viewpoint image) has been known conventionally. The viewpoint images are images captured respectively from different viewpoint positions (for example, a left-eye viewpoint position and a right-eye viewpoint position).

There is a parallax between the left-eye viewpoint image and the right-eye viewpoint image. Moreover, the left-eye viewpoint image and the right-eye viewpoint image are alternately displayed. Accordingly, a ghost image occurring due to crosstalk needs to be suppressed.

For example, the following technique is proposed. In a case where a second viewpoint image (right-eye viewpoint image or left-eye viewpoint image) is displayed subsequent to a first viewpoint image (left-eye viewpoint image or right-eye viewpoint image), the second viewpoint image is controlled so as to compensate the crosstalk of the first viewpoint image (for example, see Japanese Patent Application Publication No. 2008-72699).

In the suppression of the ghost image occurring due to the crosstalk, the contrast in the second viewpoint image has to be maintained at a certain level. A subtraction method and an addition method are conceivable as methods of maintaining the contrast in the second viewpoint image at a certain level.

To be more specific, in the subtraction method, a crosstalk amount corresponding to the first viewpoint image is subtracted from an image input signal forming the second viewpoint image. In the addition method, an inverted crosstalk amount corresponding to an inverted image of the first viewpoint image is added to the image input signal forming the second viewpoint image.

However, in the subtraction method, the ghost image is not sufficiently suppressed in a portion where a pixel value therein falls below a lower limit if the crosstalk amount is subtracted from the image input signal forming the second viewpoint image. Meanwhile, in the addition method, a “blown-out highlight” occurs in a portion where a pixel value therein exceeds an upper limit (for example, “255”) if the inverted crosstalk amount is added to the image input signal forming the second viewpoint image. Moreover, in the addition method, “brightening of black” is caused by the addition of the inverted crosstalk amount, in a portion where the pixel value is equal to the lower limit (for example “0”).

### SUMMARY OF THE INVENTION

An display apparatus of a first aspect displays a three-dimensional image formed of a plurality of viewpoint images, and includes an image controller that controls a second viewpoint image to suppress a crosstalk of a first viewpoint image the first viewpoint image and the second viewpoint image are included in the plurality of viewpoint images. The image controller switches a control mode for suppressing the crosstalk, between a subtraction mode and an addition mode in accordance with an image input signal forming the three-dimensional image.

In the first aspect, in the subtraction mode, the image controller subtracts a crosstalk amount corresponding to the first viewpoint image from the image input signal forming the second viewpoint image.

In the first aspect, in the addition mode, the image controller adds an inverted crosstalk amount corresponding to an inverted image of the first viewpoint image to the image input signal forming the second viewpoint image.

In the first aspect, the image controller adjusts the image input signal forming the second viewpoint image so as to absorb contrast change in an image region with sharp contrast change included in the first viewpoint image.

In the first aspect, the image controller adjusts the image input signal forming the second viewpoint image so as to absorb contrast change in an image region with sharp contrast change included in the inverted image of the first viewpoint image.

In the first aspect, the image controller controls the processing of absorbing the contrast change according to a position in the image.

In the first aspect, the image controller controls a shape or a size of an absorption region in which the contrast change is to be absorbed, in accordance with a position in the image.

### BRIEF DESCRIPTION OF THE DRAWINGS

FIG. 1 is a view showing a display apparatus 100 of a first embodiment.

FIG. 2 is a view showing occurrence of crosstalk in the first embodiment.

FIG. 3 is a view showing a subtraction mode of the first embodiment.

FIG. 4 is a view showing a subtraction mode of the first embodiment.

FIG. 5 is a view showing a subtraction mode of the first embodiment

FIG. 6 is a view showing a subtraction mode of the first embodiment.

FIG. 7 is a view showing a subtraction mode of the first embodiment.

FIG. 8 is a view showing an addition mode of the first embodiment.

FIG. 9 is a view showing an addition mode of the first embodiment.

FIG. 10 is a view showing the addition mode of the first embodiment.

FIG. 11 is a view showing the addition mode of the first embodiment.

FIG. 12 is a view showing the addition mode of the first embodiment.

FIG. 13 is a view showing an image example of Modification 1.

FIG. 14 is a view showing an image example of Modification 1.

FIG. 15 is a view showing an image example of Modification 1.

### DETAILED DESCRIPTION OF THE EMBODIMENTS

A display apparatus according to embodiments of the present invention will be described below with reference to the drawings. In the following drawings, identical or similar constituents are denoted by identical or similar reference numerals.

### OVERVIEW OF EMBODIMENT

A display apparatus of an embodiment displays a three-dimensional image formed of a plurality of viewpoint images, and includes an image controller that controls a second viewpoint image to suppress a crosstalk of a first viewpoint image the first viewpoint image and the second viewpoint image are included in the plurality of viewpoint images. The image controller switches a control mode for suppressing the crosstalk, between a subtraction mode and an addition mode in accordance with an image input signal forming the three-dimensional image.

In the embodiment, the image controller switches the control mode for suppressing the crosstalk, between the subtraction mode and the addition mode in accordance with the image input signal forming the three-dimensional image. Thus, “ghost image”, “brightening of black”, and “blown-out highlight” is suppressed.

Note that, the “crosstalk” is such a phenomenon that an image enters an eye different from an eye by which the image is intended to be seen. This phenomenon is conceived to be caused by an interference which occurs due to the reaction speed of a liquid crystal display, an interference which occurs due to afterglow of a plasma display, or an interference which occurs due to the performance (shutter speed, degree of polarization, degree of light shielding, and the like) of an eye-glass used to view the three-dimensional image.

Moreover, the first viewpoint image is an image interfering with the second viewpoint image, and the second viewpoint image is an image being interfered by the first viewpoint image. For example, in a case where a left-eye viewpoint image and a right-eye viewpoint image are displayed in a time division manner, the first viewpoint image is an (n−1)th viewpoint image to be displayed, and the second viewpoint image is an n-th viewpoint image to be displayed. Meanwhile, in a case where the left-eye viewpoint image and the right-eye viewpoint image are displayed simultaneously, the first viewpoint image is the left-eye viewpoint image (or right-eye viewpoint image) and the second viewpoint image is the right-eye viewpoint image (or left-eye viewpoint image) (glassless two viewpoint display).

Note that, the embodiment describes an example of a case where the first viewpoint image is the left-eye viewpoint image and the second viewpoint image is the right-eye viewpoint image. However, the embodiment is not limited to this configuration as matter of course.

### First Embodiment

### Configuration of Display Apparatus

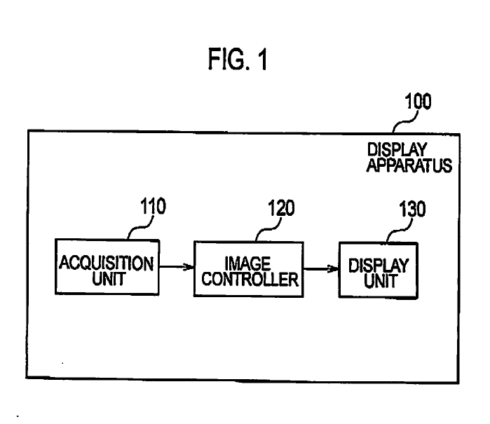

A display apparatus of a first embodiment will be described below with reference to the drawings. FIG. 1 is a view showing a display apparatus 100 of the first embodiment.

The display apparatus 100 includes an acquisition unit 110, an image controller 120, and a display unit 130. The display apparatus 100 is a liquid crystal television, a plasma television, or the like.

The acquisition unit 110 is configured to acquire an image input signal forming a three-dimensional image. For example, the acquisition unit 110 acquires the image input signal from an apparatus such as a television tuner, a DVD player, a personal computer, or the like.

The image controller 120 is configured to control a viewpoint image to be displayed on the display unit 130. For example, the image controller 120 controls a second viewpoint image (here, right-eye viewpoint image) to suppress a crosstalk of a first viewpoint image (here, left-eye viewpoint image). The image controller 120 switches a control mode for suppressing the crosstalk, between a subtraction mode and an addition mode in accordance with the image input signal forming the three-dimensional image.

To be more specific, in the subtraction mode, the image controller 120 subtracts a crosstalk amount corresponding to the first viewpoint image from the image input signal forming the second viewpoint image. Here, the image controller 120 preferably adjusts the image input signal forming the second viewpoint image in a way to absorb contrast change in an image region with sharp contrast change in the first viewpoint image.

Meanwhile, in the addition mode, the image controller 120 adds an inverted crosstalk amount corresponding to an inverted image of the first viewpoint image to the image input signal forming the second viewpoint image. Here, the image controller 120 preferably adjusts the image input signal forming the second viewpoint image in a way to absorb contrast change in an image region with sharp contrast change in the inverted image of the first viewpoint image.

Note that, the inverted image of the first viewpoint image is an image formed of an inverted image input signal obtained by inverting the image input signal forming the first viewpoint image.

The image controller 120 applies the subtraction mode instead of the addition mode in the following case. There is no pixel whose pixel value falls below a lower limit even if the crosstalk amount is subtracted from the image input signal forming the second viewpoint image. Note that, “ghost image”, “brightening of black”, and “blown-out highlight” do not occur in such case, since there is no such pixel that a pixel value thereof falls below a lower limit even if the crosstalk amount is subtracted from the image input signal forming the second viewpoint image.

The image controller 120 applies the subtraction mode instead of the addition mode in the following case. There is a pixel whose pixel value exceeds an upper limit if the inverted crosstalk amount is added to the image input signal forming the second viewpoint image. Such application is performed even if there is a pixel whose pixel value falls below the lower limit if the crosstalk amount is subtracted from the image input signal forming the second viewpoint image. Note that, “blown-out highlight” is suppressed by applying the subtraction mode in such case, since there is a pixel whose pixel value exceeds an upper limit if the inverted crosstalk amount is added to the image input signal forming the second viewpoint image. Furthermore, in the subtraction mode, “ghost image” is suppressed, since contrast change is absorbed in an image region with sharp contrast change. However, “brightening of black” inevitably occurs.

The image controller 120 applies the addition mode instead of the subtraction mode in the following case. There is a pixel whose pixel value falls below the lower limit if the crosstalk amount is subtracted from the image input signal forming the second viewpoint image and there is no pixel whose pixel value exceeds the upper limit even if the inverted crosstalk amount is added to the image input signal forming the second viewpoint image. Note that, in such case, “blown-out highlight” does not occur even if the addition mode is applied, since there is no such pixel that a pixel value thereof exceeds the upper limit even if the inverted crosstalk amount is added to the image input signal forming the second viewpoint image.

The display unit 130 is a display such as a liquid crystal display or a plasma display.

### (Occurrence of Crosstalk)

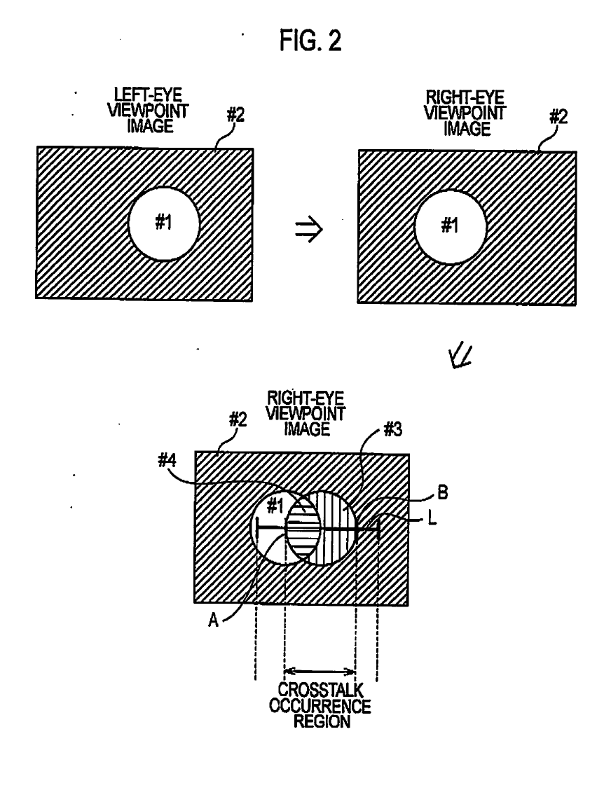

The occurrence of the crosstalk will be described below with reference to FIG. 2. In FIG. 2, in order to simplify the description, an example is given of a case where the first viewpoint image (here, left-eye viewpoint image) and the second viewpoint image (here, right-eye viewpoint image) are each formed of a first image region #1 and a second image region #2. The first image region #1 is, for example, an image region (object image region) with high brightness, and is provided with a parallax between the left-eye viewpoint image and the right-eye viewpoint image. The second image region #2 is, for example, an image region (background image region) with low brightness, and is provided with no parallax between the left-eye viewpoint image and the right-eye viewpoint image.

When the crosstalk from the left-eye viewpoint image (interference from the left-eye viewpoint image to the right-eye viewpoint image) occurs in such case, the brightnesses of an image region #3 and an image region #4 are increased in the right-eye viewpoint image. In other words, crosstalk occurs on a straight line L between a pixel A and a pixel B.

### (Subtraction Mode)

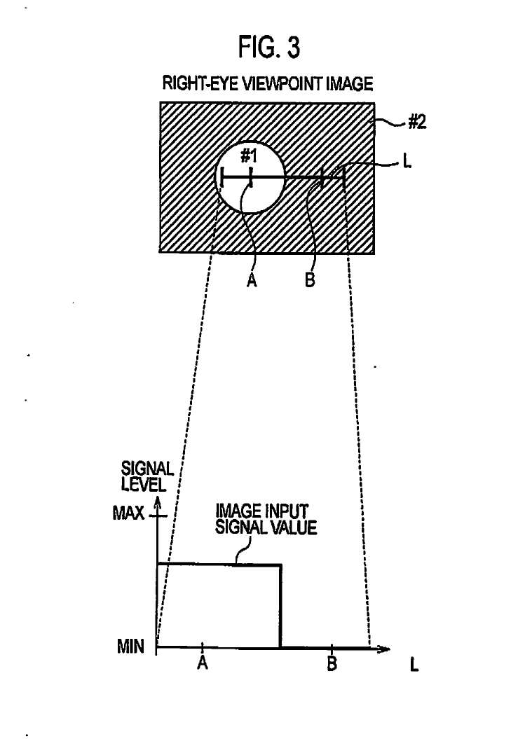

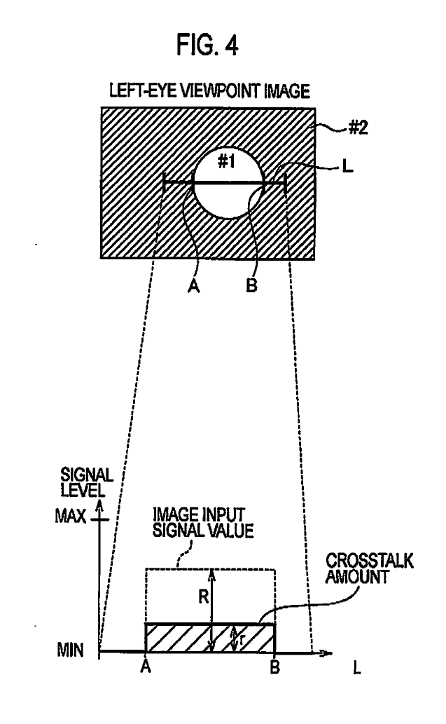

The subtraction mode will be described below with reference to FIGS. 3 to 7. As shown in FIG. 3, the right-eye viewpoint image is formed of the image region #1 and the image region #2. As shown in FIG. 4, the crosstalk amount corresponding to the left-eye viewpoint image is a value obtained by multiplying a constant ratio “rift” to the image input signal value (for example, brightness) of the image region #1.

Here, the signal level of the image input signal forming the image region #2 of the right-eye viewpoint image is “MIN (for example, “0”). Thus, the crosstalk amount corresponding to the left-eye viewpoint image cannot be subtracted from the image input signal forming the image region #2 of the right-eye viewpoint image.

Accordingly, the image controller 120 calculates a signal value (addition signal value) to be added to the image input signal forming the right-eye viewpoint image, on an assumption that the crosstalk amount corresponding to the left-eye viewpoint image is to be subtracted.

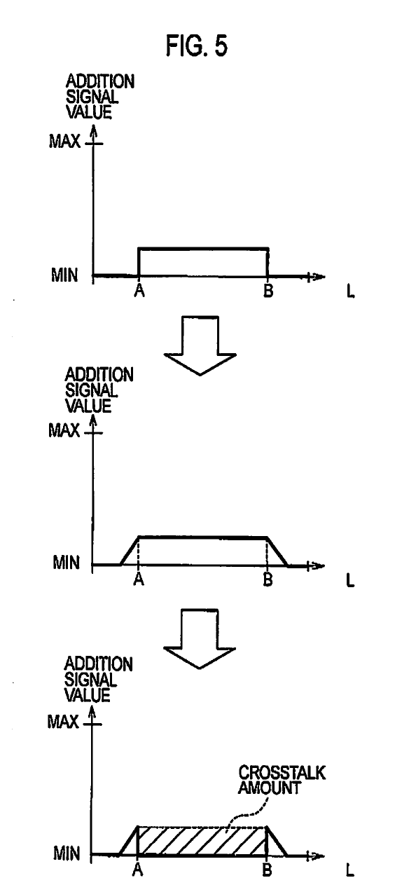

As shown in FIG. 5, the image controller 120 first sets the crosstalk amount corresponding to the left-eye viewpoint image as the addition signal value. Secondly, the image controller 120 corrects the addition signal value so that the change in an image to be displayed is to be within a predetermined threshold for pixels close to the pixel A and the pixel B, more specifically, so that the changes in addition signal value between adjacent pixels is within the predetermined threshold. Thirdly, the image controller 120 subtracts the crosstalk amount corresponding to the left-eye viewpoint image from the addition signal value.

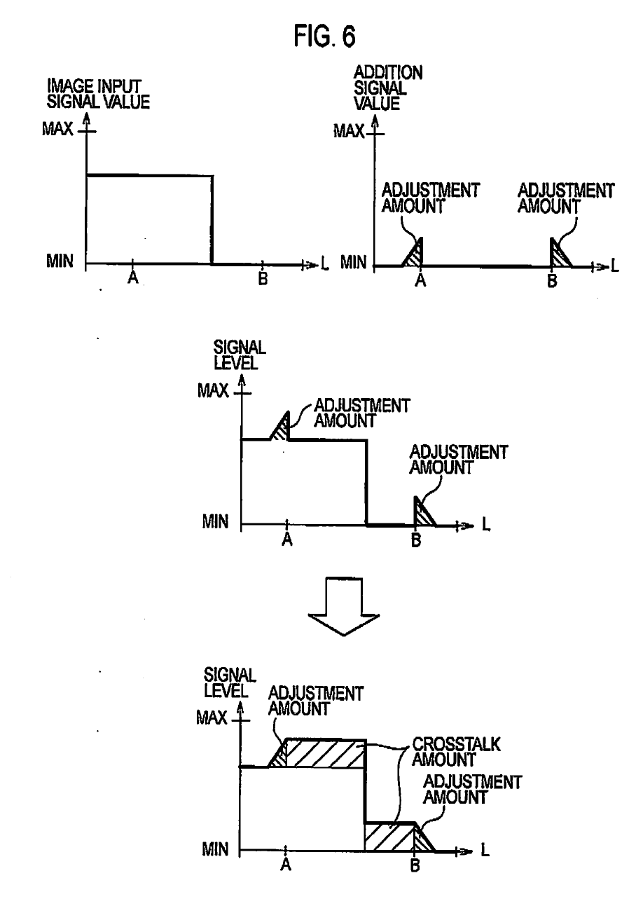

As shown in FIG. 6, the image controller 120 subsequently adds the addition signal value to the image input signal forming the right-eye viewpoint image. Finally, the stroke amount corresponding to the left-eye viewpoint image is added, and thus the signal level of the actual right-eye viewpoint image to be viewed by a user is determined.

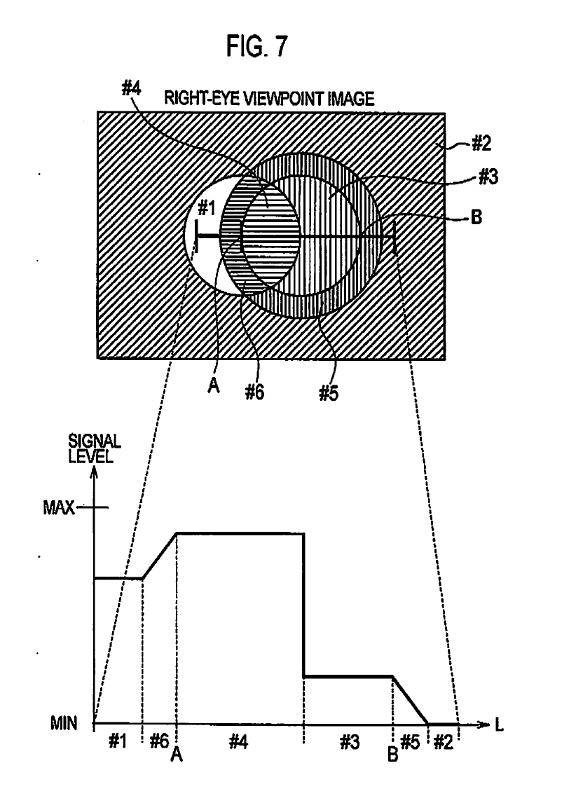

For example, as shown in FIG. 7, in the actual right-eye viewpoint image to be viewed by the user, an image region #5 and an image region #6 in which the contrast change is absorbed is provided around the image region #3 and the image region #4 (crosstalk occurrence region). Provision of such image region #5 and image region #6 in which the contrast change is absorbed causes the contour of the “ghost image” to blur, and thus the “ghost image” is made less visible.

Note that, the image region in which the contrast change is absorbed is an image region in which the image input signal is adjusted. For example, the image region in which the contrast change is absorbed is the image region #5 and the image region #6.

### (Addition Mode)

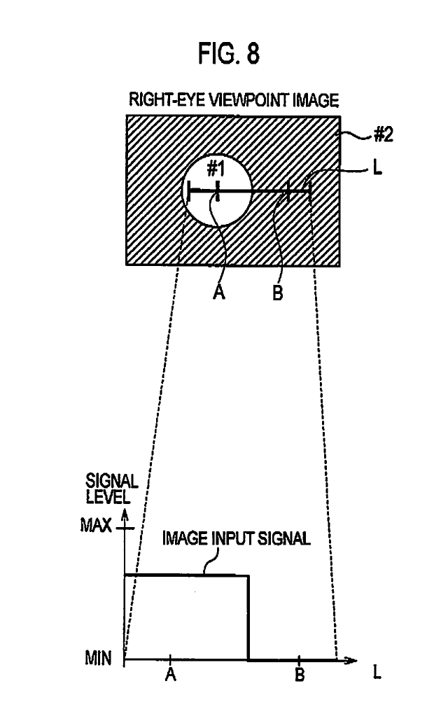

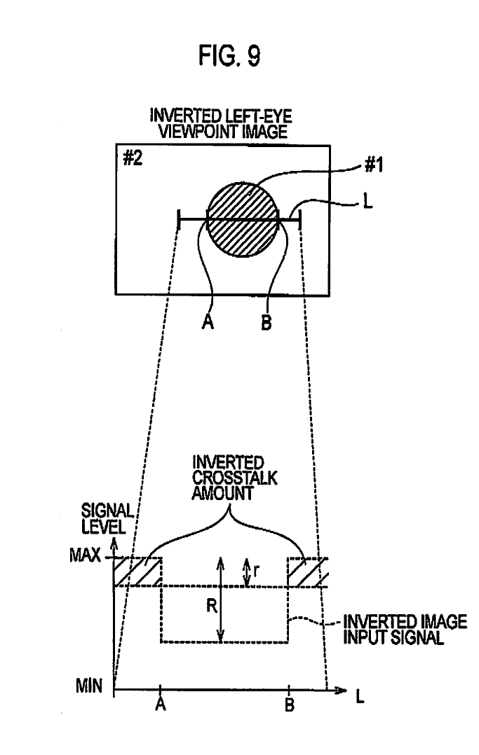

The addition mode will be described below with reference to FIGS. 8 to 12. As shown in FIG. 8, the right-eye viewpoint image is formed of the image region #1 and the image region #2. As shown in FIG. 9, the inverted crosstalk amount corresponding to the inverted image of the left-eye viewpoint image is a value obtained by multiplying the constant ratio “r/R” to an inversion image input signal value (for example, brightness) of the image region #1. The constant ratio “rat” is determined based on the performance of the display and the performance of an eye-glass.

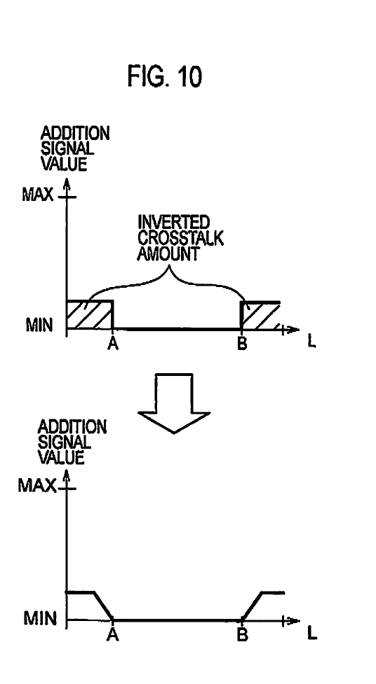

As shown in FIG. 10, the image controller 120 first sets the inverted crosstalk amount corresponding to the inverted image of the left-eye viewpoint image as the addition signal value. Secondly, the image controller 120 corrects the addition signal value so that the change in an image to be displayed is to be within a predetermined threshold for pixels close to the pixel A and the pixel B, more specifically, so that the change in addition signal value between adjacent pixels is within the predetermined threshold.

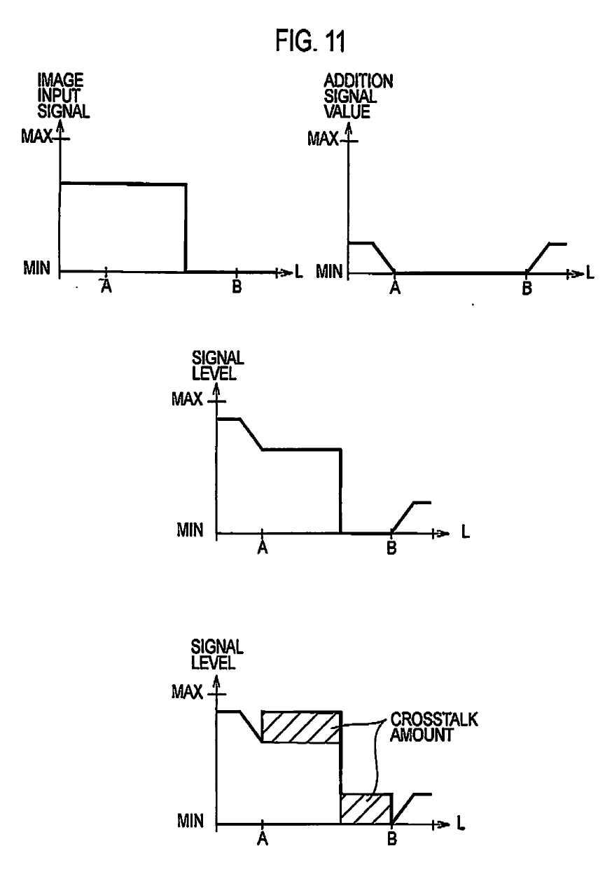

As shown in FIG. 11, the image controller 120 subsequently adds the addition signal value to the image input signal forming the right-eye viewpoint image. Finally, the stroke amount corresponding to the left-eye viewpoint image is added, and thus the signal level of the actual right-eye viewpoint image to be viewed by the user is determined.

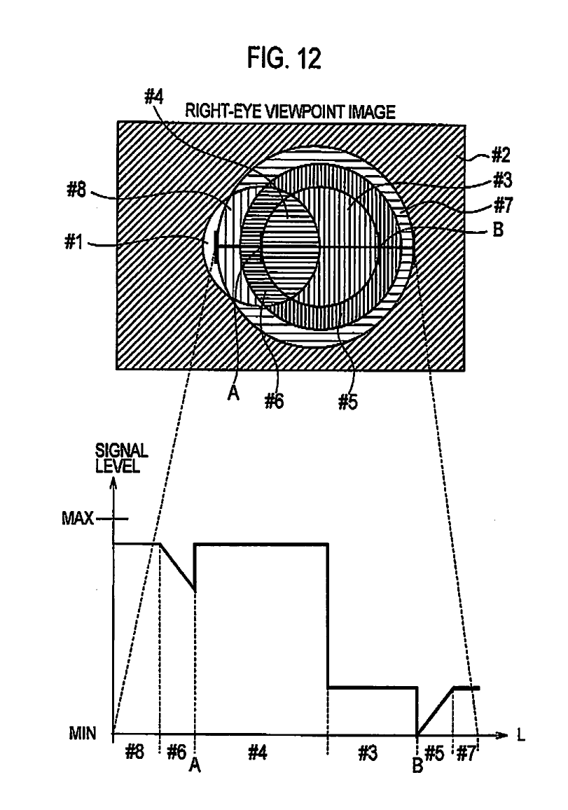

For example, as shown in FIG. 12, in the actual right-eye viewpoint image to be viewed by the user, the image region #5 and the image region #6 in which the contrast change is absorbed is provided around the image region #3 and the image region #4 (crosstalk occurrence region). An image region #7 and an image region #8 in which the addition signal value is added is provided around the image region #5 and the image region #6.

Note that, the image region in which the contrast change is absorbed is an image region in which the image input signal is adjusted. For example, the image region in which the contrast change is absorbed is the image region #5 and the image region #6.

### (Operation and Effect)

In the first embodiment, the image controller 120 switches the control mode for suppressing the crosstalk, between the subtraction mode and the addition mode in accordance with the image input signal forming the three-dimensional image. Accordingly, “ghost image”, “brightening of black”, and “blown-out highlight” are suppressed.

### [Modification 1]

Modification 1 of the first embodiment will be described below. The differences from the first embodiment will be mainly described below.

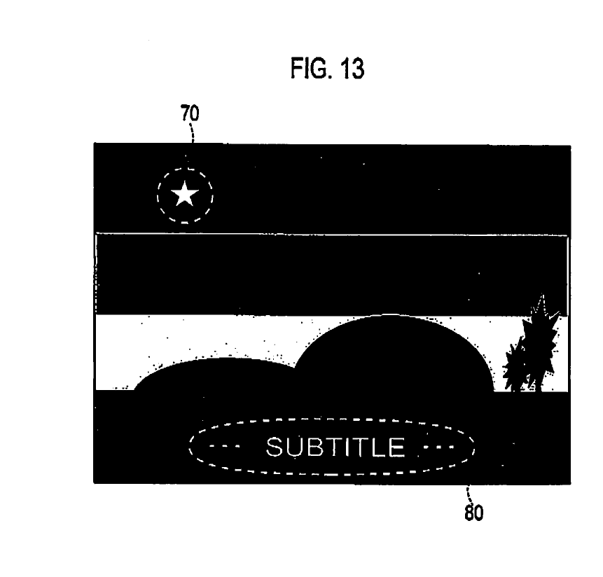

Specifically, in Modification 1, the image controller 120 controls the processing of absorbing the contrast change in accordance with a position in the image. Note that, Modification 1 will be described by giving an example of an image of a nightscape as illustrated in FIGS. 13 to 16. In this image, there are mountains and trees in the background, and as a whole, there is a gradation in which the brightness gradually changes. In the image, there is a star 70 shining in a dark region (night sky). Moreover, there is a subtitle 80 in outline letters in the dark region. A consideration is made mainly on a region as described above in which the brightness of a region (background) around a specific region is lower than a predetermined threshold and the brightness of the specific region is higher than a predetermined threshold.

Firstly, the image controller 120 absorbs the contrast change in the specific region, and does not absorb the contrast change in a region other than the specific region.

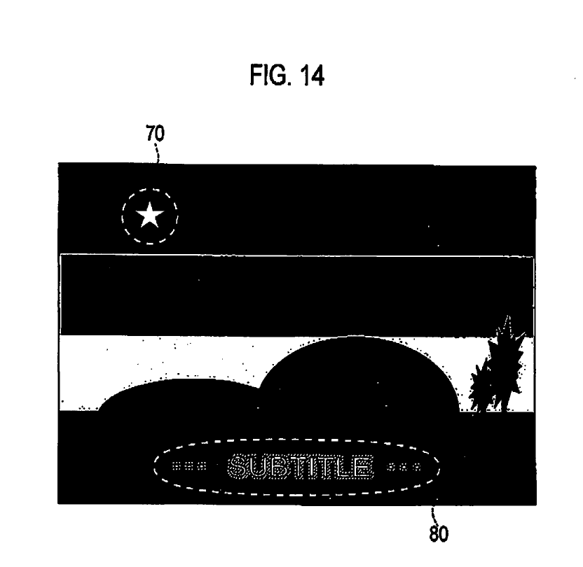

Secondly, the image controller 120 sets a region larger than an absorption region corresponding to the region other than the specific region as an absorption region corresponding to the specific region. Note that, the absorption region is an image region in which the contrast change is absorbed. For example, as shown in FIG. 14, the absorption region is provided around the subtitle 80 in outline letters.

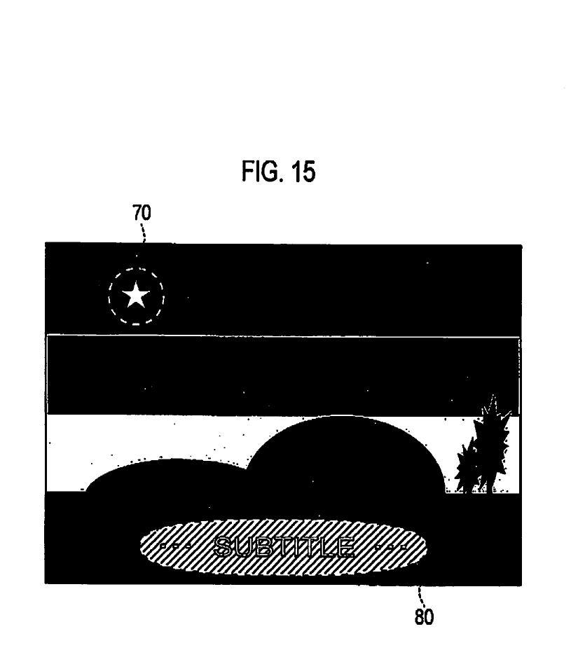

Thirdly, the image controller 120 sets a region having a predetermined shape (for example, an oval or a rectangle) as an absorption region corresponding to the specific region. For example, as shown in FIG. 15, an oval-shaped absorption region is provided in a manner including the subtitle 80 in outline letters.

The specific region is designated as described below, for example. (1) The image controller 120 extracts a frequency component for every line (for example, a line in horizontal direction) included in the image, and designates a region in which the number of lines is equal to or larger than a predetermined number, as the specific region, the lines each having an average value of the frequency component higher than a predetermined threshold. Alternatively, (2) the image controller 120 designates a predetermined region as the specific region. Note that, a region where the subtitle 80 is to be displayed is predetermined in some cases. The method of (2) is effective in such case.

Fourthly, the image controller 120 calculates a representative value (total value or average value) of contrast for each of multiple image regions forming the image. Then, a larger region is set as the absorption region in an image region with larger representative value of contrast.

Fifthly, the image controller 120 performs such setting that the closer the image region is to the center of image, the smaller a region set as the absorption region is, and that the closer the image region is to the edge of the image, the larger a region set as the absorption region is.

### Other Embodiments

As described above, the details of the present invention have been disclosed by using the embodiment of the present invention. However, it should not be understood that the description and drawings which constitute part of this disclosure limit the present invention. From this disclosure, various alternative embodiments, examples, and operation techniques will be easily found by those skilled in the art.

In the embodiment, the example is given of a case where the multiple viewpoint images forming the three-dimensional image are the left-eye viewpoint image and the right-eye viewpoint image. However, the embodiment is not limited to this configuration. For example, the multiple viewpoint images may include three or more viewpoint images.

In the embodiment, the control mode for suppressing the crosstalk is switched between the subtraction mode and the addition mode. Examples of a timing at which the control mode is switched include a timing of a scene change, a change timing of a user setting, a timing specified by the user, and the like.

In the embodiment, when the control mode for suppressing the crosstalk is determined, it is judged whether or not the pixel value falls below the lower limit if the crosstalk amount is subtracted from the image input signal forming the second viewpoint image. In such case, judgment can be made on whether or not the pixel value of any pixel among all the pixels falls below the lower limit, or judgment can be made on whether or not the average pixel value of all the pixels falls below the lower limit.

1. An display apparatus for displaying a three-dimensional image formed of a plurality of viewpoint images, the display apparatus comprising
an image controller that controls a second viewpoint image to suppress a crosstalk of a first viewpoint image the first viewpoint image and the second viewpoint image are included in the plurality of viewpoint images, wherein
the image controller switches a control mode for suppressing the crosstalk, between a subtraction mode and an addition mode in accordance with an image input signal forming the three-dimensional image.

2. The display apparatus according to claim 1, wherein, in the subtraction mode, the image controller subtracts a crosstalk amount corresponding to the first viewpoint image from the image input signal forming the second viewpoint image.

3. The display apparatus according claim 1, wherein, in the addition mode, the image controller adds an inverted crosstalk amount corresponding to an inverted image of the first viewpoint image to the image input signal forming the second viewpoint image.

4. The display apparatus according to claim 2, wherein the image controller adjust the image input signal forming the second viewpoint image so as to absorb contrast change in an image region with sharp contrast change included in the first viewpoint image.

5. The display apparatus according to claim 8, wherein the image controller adjust the image input signal forming the second viewpoint image so as to absorb contrast change in an image region with sharp contrast change included in the inverted image of the first viewpoint image.

6. The display apparatus according to claim 4, wherein the image controller controls the processing of absorbing the contrast change according to a position in the image.

7. The display apparatus according to claim 4, wherein the image controller controls a shape or a size of an absorption region in which the contrast change is to be absorbed, in accordance with a position in the image.

8. The display apparatus according to claim 5, wherein the image controller controls the processing of absorbing the contrast change according to a position in the image.

9. The display apparatus according to claim 5, wherein the image controller controls a shape or a size of an absorption region in which the contrast change is to be absorbed, in accordance with a position in the image.
